(19) United States
(12) Patent Application Publication
(10) Pub. No.: US 2020/0344314 A1
(43) Pub. Date: Oct. 29, 2020

(54) GROUPING OF MOBILE DEVICES FOR LOCATION SENSING

(71) Applicant: Sony Corporation, Tokyo (JP)

(72) Inventors: Anders MELLQVIST, Lund (SE); Basuki PRIYANTO, Lund (SE); Henrik SUNDSTROM, Lund (SE); Lars NORD, Lund (SE); Anders ISBERG, Åkarp (SE); Andrej PETEF, Lund (SE)

(21) Appl. No.: 16/960,966

(22) PCT Filed: Jan. 12, 2018
(86) PCT No.: PCT/EP2018/050765

§ 371 Date: Jul. 9, 2020

(51) Int. Cl. H04L 29/08; H04W 24/10; H04W 72/04; H04W 84/18; G06N 20/00; H04W 4/70

(52) U.S. Cl. CPC H04L 67/2804; H04L 67/12; H04W 24/10; H04W 4/70; H04W 84/18; G06N 20/00; H04W 72/042

(57) ABSTRACT

Methods (10A; 10B) for grouping of mobile devices are provided. A method (10B) comprises receiving (15B), from each mobile device (40A-40C) of a plurality of mobile devices (40A-40C), control data (30A, 30B) indicative of at least one anomaly detected in a time series of measurement values of a physical observable monitored by a sensor (43) of the respective mobile device (40A-40C); determining (17), based on a comparison of anomalies indicated by the control data (30A, 30B) from the plurality of mobile devices (40A-40C), an assignment of the plurality of mobile devices (40A-40C) into at least one location sensing group; and implementing (20B) group sensor reporting in accordance with the at least one location sensing group.

### FIELD OF THE INVENTION

Various embodiments of the invention relate to methods for group sensor reporting and respective grouping of mobile devices, and to devices operating according to these methods. Various embodiments relate in particular to methods and devices operable in cellular networks and in connection with Internet of Things contexts.

### BACKGROUND OF THE INVENTION

Cost and size of Internet of Things, IoT, devices are decreasing rapidly. It will be possible to equip more items with communication technologies such as Low Power Wide Area Network, LPWAN, Wide Area Network, WAN, or Bluetooth Low Energy, BLE. This will enable new types of applications; for example in the logistics industry it will be possible to monitor individual items instead of a set of items within a container or loaded onto a truck.

However, battery power will still continue to be a limited resource, as IoT devices become smaller and the size of the battery also becomes smaller. While WAN radio communication, such as cellular technology, will continue to require significant energy in such devices, one approach to reduce the battery consumption is to group a cluster of IoT devices that are located in close vicinity and treat those as an entity, hence the burden of reporting sensing data over the network can be distributed among the devices in the cluster.

For example, in a mobile tracking application, a location is the same for all devices in close vicinity. Grouping of mobile devices and associated group sensor reporting could be used to either share the reporting burden among the mobile devices, or increase the reporting frequency for the cluster as a whole to achieve better positional granularity. Once it is detected that a mobile device leaves a group, this device will revert back to report sensing data as a standalone unit.

Identifying groups or clusters of devices for group sensor reporting is a well-known problem and several solutions have been proposed.

For example, short-range communication technologies may be used to detect that devices are in close vicinity. One drawback of this solution is that there is a need of having the devices to communicate with each other.

Alternatively, statistical methods may be applied upon reported sensing data to conclude that devices are in close vicinity, e.g. by comparing positional information. This solution takes a long time if the devices are reporting data with low frequency independently of each other. It requires that many data points are gathered before the cluster can be formed.

### BRIEF SUMMARY OF THE INVENTION

In view of the above, there is a continued need in the art for methods and devices which address some of the above needs.

These underlying objects of the invention are each solved by the independent claims. Preferred embodiments of the invention are set forth in the dependent claims.

According to a first aspect, a method is provided. The method comprises: receiving, from each mobile device of a plurality of mobile devices, control data indicative of at least one anomaly detected in a time series of measurement values of a physical observable monitored by a sensor of the respective mobile device; determining, based on a comparison of anomalies indicated by the control data from the plurality of mobile devices, an assignment of the plurality of mobile devices into at least one location sensing group; and implementing group sensor reporting in accordance with the at least one location sensing group.

Advantageously, grouping of mobile devices may be facilitated based on sensor data originating from any sensor such as, for example, an accelerometer, a pressure sensor, a gyroscope, a photodiode, temperature sensor, or a microphone. Different sensors measure different physical observables.

Advantageously, grouping of mobile devices may be based on events appearing as the at least one anomaly indicated in the respective control data received from different mobile devices, without a need for receiving many data points.

Advantageously, grouping of mobile devices may be facilitated even if dedicated positioning sensors, for example Global Positioning System, GPS, sensors or the like, would be unavailable or temporarily have no reception. Therefore, device grouping based on comparing anomalies may be more precise and robust than legacy device grouping, and may improve preciseness and robustness of legacy device grouping.

Advantageously, implementing group sensor reporting in accordance with determined location sensing groups may reduce battery consumption of the plurality of mobile devices of the respective location sensing group since these mobile devices can be treated as an entity.

The term “mobile device” as used herein may refer to an apparatus capable of moving or being moved and comprising a radio interface by which communication technologies such as LPWAN, WAN or BLE establish and maintain connectivity to a wireless network, in particular to a cellular network. Examples for such mobile devices comprise smartphones, computers, Machine Type Communication (MTC) devices, and Narrowband Internet of Things (NB-IoT) devices.

The term “wireless network” as used herein may refer to a communication network which comprises wireless/radio links between network nodes, besides fixed network links interconnecting the functional entities of the wireless network's infrastructure. Examples for such a network comprise Universal Mobile Telecommunications System, UMTS, and Third Generation Partnership Project, 3GPP, Long Term Evolution, LTE, cellular networks, New Radio, NR, 5G networks, Long Range radio, LoRa, etc. Generally, various technologies of wireless networks may be applicable and may provide (LP)WAN connectivity.

The term “anomaly” as used herein draws on anomaly detection, i.e. a technique used to identify unusual patterns, called anomalies or outliers that do not conform to a baseline behavior. For example, anomalies may refer to observations or events in a given dataset which do not conform to an expected pattern. It would be possible that measurement values associated with a given anomaly are significantly different from other measurement values not associated with the given anomaly. For example, the anomaly may be a peak or dip in measurement values, e.g., having a certain statistical significance. In other examples, an anomaly may be defined by a certain pattern of peaks and/or dips in the measurement values—e.g., three consecutive peaks, spaced apart not more than 500 ms, etc. As will be appreciated, the specific characteristic of the anomaly may vary from sensor to sensor. For example, it is expected that a pressure sensor may show different anomalies in the time series of measurement values than a gyroscope.

Different anomalies may show a different characteristic behavior—sometimes called fingerprint of the anomaly. For example, the measurement values may show a different time-dependency for different anomalies. For example, a first anomaly may be associated with a fingerprint indicative of “three consecutive peaks in the measurement values”; while a second anomaly may be associated with a fingerprint indicative of “three consecutive dips in the measurement values”. The different anomalies may be labeled.

The term “time series” as used herein may refer to a series of measurement values indexed in time order, and in particular measured at consecutive and equally spaced time instants, which is known as sampling.

The term “physical observable” as used herein may refer to a physical quantity whose instantaneous value can be determined by measurement. Examples include: pressure; sound; brightness; acceleration; temperature; etc.

The term “sensor” as used herein may refer to a functional entity of a device used to detect events or changes in the environment of the device. Sensors may include analog-digital-converters.

For example, an accelerometer is a sensor which may be used to detect the physical observable of acceleration of the sensor and its device host with respect to the environment of the device, in units of m/s².

The term “location sensing group” as used herein may refer to a plurality of mobile devices which move or are being moved jointly, without necessarily knowing of each other, and which may be managed jointly by the network due to their vicinity to each other.

The term “group sensor reporting” as used herein may refer to techniques allowing the plurality of mobile devices of a location sensing group to report anomalies in their respective sensor data for inference of a joint location of the location sensing group. For example, this may be achieved by coordinating the sensor reporting of the individual mobile devices of the location sensing group to either share the reporting burden among the plurality of mobile devices, or to increase the reporting frequency for the group as a whole to achieve better positional granularity. It shall be appreciated that various group sensor reporting assignments can be assigned to the mobile devices in the location sensing group e.g. temperature, humidity, location, and the like. A group head may be set; the group head may control or implement sensor reporting. The group head functionality may be assigned to one mobile device or implemented in an application server.

According to some embodiments, the control data is indicative of at least one of a timestamp of the at least one anomaly, and a label associated with the at least one anomaly, the label being identified in accordance with a respective detector model used by the respective mobile device of the plurality of mobile devices for detecting the anomalies in the time series of measurement values.

Advantageously, comparing anomalies indicated by respective associated labels may reduce battery consumption of the respective mobile devices by transmitting essential control data only, and may reduce power consumption of a receiving and data-processing network node by simplifying the comparison itself.

The term “label” as used herein may refer to an identifier that represents the at least one anomaly when detected using a detector model that may be preconfigured by the network node.

In particular, a label may be assigned to the at least one anomaly if the at least one anomaly is detectable using a network-configured detector model and therefore represents a “known anomaly pattern”. Different labels may correspond to different anomalies.

The labeled anomaly pattern may furthermore be associated with location information, meaning that the detector model not only detects an anomaly but also implicitly finds the current location of the mobile device.

Example labels include: road bump; left turn; right turn; highway entry; highway exit; speed bumps; etc.

As will be appreciated, the data size of the label may be significantly smaller than the data size of the measurement values comprising the at least one anomaly. This helps to reduce a required bandwidth.

For example, if the at least one anomaly is recognized with a high significance, e.g. with relation to a given significance threshold, the at least one anomaly could be indicated in the corresponding control data sent to the network node by a short label, instead of by an extensive portion of the time series.

The term “significance” as used herein may refer to a certainty of recognition of the at least one anomaly by a network-configured detector model. For example, a significance of recognition of 0% may represent that a network-configured detector model is unavailable, or has been configured on the basis of anomalies other than the at least one anomaly. Conversely, a significance of recognition of 100% may indicate that a network-configured detector model encounters the at least one anomaly once again after the detector model has been configured based on the at least one anomaly. Owing to the analog nature of the monitored physical observables, a significance of recognition may be lower than 100%.

The term “detector model” as used herein may refer to a model built from sample data which enables anomaly detection in the time series of measurement values. For example, a simple statistical detector model may involve a multiple of a moving average value of the time series as a threshold to determine outliers, or anomalies, in the time series. More complex detector models may, for example, involve machine learning, in particular based on artificial neural networks.

According to some embodiments, the control data is indicative of at least one of a portion of the time series of measurement values comprising the at least one anomaly, and a location information of the respective mobile device at the time of occurrence of the at least one anomaly.

Such an implementation of the control data may be helpful where it is not possible to reliable detect the anomaly at each individual mobile device. For example, the significance with which a given anomaly is detected by a given mobile device may be limited. Then, based on the measurement values obtained in the control data from the plurality of mobile device, a more reliable detection of an anomaly may be centrally performed, e.g., by correlations between the various measurement values.

Further, such an implementation of the control data may be helpful where—e.g., due to the complexity—it is not easily possible to categorize each anomaly into a given label. Then, ambiguities may be avoided by provided the measurement values. Also, a priori knowledge on the type of the anomaly may not be available.

Further, such an implementation of the control data may be helpful where a detector model used for detecting the anomaly has not yet been properly trained.

Advantageously, comparing anomalies indicated by the control data from the plurality of mobile devices using the measurement values facilitates assigning the plurality of mobile devices into location sensing groups when no extensive base of sensor data is available yet, and/or in case of anomalies which have not been observed yet.

Based on the portion of the time series of the measurement values, it can be possible to train a correlation model. This may help to identify whether certain anomalies are in principle suited for being used as a decision criterion in the grouping of devices.

The term “training” as used herein may generally refer to a procedure in which a function, for example a decision-making function, is inferred from data collected in the past. Particularly in a machine learning context, training may relate to supervised learning based on a set of training examples consisting of an input value or vector and a desired output value, or to unsupervised learning based on training examples wherein the control data from the plurality of mobile devices is used as input and an outcome of a comparison of anomalies indicated by the control data from the plurality of mobile devices is used as the desired output value.

The term “machine learning” as used herein may refer to computational methods for data-driven learning and decision-making without involving any data-specific programming.

The term “timestamp” as used herein may refer to a timing information of the portion of the time series within the time series, and/or with respect to absolute time. For example, a timestamp may be representative of a start time and/or end time of the portion of the time series comprising the at least one anomaly. A common time reference may be used for the plurality of devices.

The term “portion of the time series” as used herein may refer to a section of the time series having no gaps or having gaps, but in any case comprising those measurement values which are indicative of the at least one anomaly.

The term “location information” as used herein may refer to information defining a particular geographic location. For example, location information may comprise latitude and longitude information, optionally altitude information, and may e.g. be represented as decimal degrees, as degrees—minutes—seconds, or in any other representation. The location information may be representative of a last known access point or cell of a wireless or cellular network, sector of a cell, or the position of the mobile device itself.

According to some embodiments, the physical observable is selected from the group comprising: acceleration; position; rotation; sound pressure; temperature; pressure; luminescence.

According to some embodiments, the method further comprises: comparing the anomalies of the plurality of mobile devices based on a correlation model. At least one parameter of the correlation model is configured by a machine learning technique.

Advantageously, machine learning may allow for continuous adaptation and improvement of device grouping as more sensor data is captured in a live system. For example, as indicated above, the correlation model may be trained based on measurement values received along with the control data.

Advantageously, machine learning may allow for data-driven learning and decision-making without involving any data-specific programming.

Advantageously, machine learning may allow for reducing reporting frequencies of the mobile devices and/or improve the clustering granularity, by inferring from the comparing of the anomalies which anomalies are relevant or important for device grouping.

The term “correlation model” as used herein may refer to any model which enables correlation of anomalies, e.g., based on labels or portions of a respective time series of measurement values. For example, a simple correlation model may involve cross-correlation as a measure of similarity of two portions of different time series which are aligned with one another based on their respective timestamps. More complex correlation models may, for example, involve machine learning, in particular based on artificial neural networks.

According to some embodiments, the machine learning technique operates based on the time series of measurement values. A portion thereof may be indicated by the control data.

According to some embodiments, the method further comprises: verifying the determined assignment based on reference control data not originating from the sensors of the plurality of mobile devices.

Advantageously, this enables recognition and taking appropriate action if the location sensing group deviates from what is expected.

The term “reference control data” as used herein may refer to external data such as parcel lists or an order database which reflects one or more expected group assignments and against which a determined location sensing group can be compared.

According to some embodiments, the machine learning technique further operates based on the reference control data.

Advantageously, this may facilitate machine learning based on training examples consisting of an input value or vector and a desired output value, by reference control data providing the desired output values.

According to some embodiments, the method further comprises: receiving, from at least one mobile device of the plurality of mobile devices, uplink training control data indicative of the time series of measurement values; based on the uplink training control data: configuring at least one parameter of the respective detector model used by the at least one mobile device of the plurality of mobile devices for detecting the anomalies; and transmitting, to the at least one mobile device of the plurality of mobile devices, downlink control data comprising at least one parameter of the respective detector model.

Additionally, the configuring may be based on a machine learning technique.

The term “uplink” as used herein may refer to a communication direction from a terminal device, in particular a mobile device, towards a network, in particular a wireless network.

Advantageously, based on the respective uplink training control data and on the outcome of the comparison of anomalies indicated by the uplink training control data from the plurality of mobile devices, the respective detector model may be configured and also be further improved as more sensor data is captured in a live system. This may help to more reliable detect anomalies. Further, new types of anomalies can be trained. Respective labels may be assigned.

The term “downlink” as used herein may refer to a communication direction from a network, in particular a wireless network, towards a terminal device, in particular a mobile device.

According to some embodiments, configuring the at least one parameter of the respective detector model comprises: training a respective detector model used by the at least one mobile device of the plurality of mobile devices for detecting the anomalies.

Advantageously, training a respective detector model may allow for data-driven learning and decision-making without involving any data-specific programming.

According to a second aspect, a method of operating a mobile device is provided. The method comprises: receiving, from a network node of a network, downlink control data comprising at least one parameter of a detector model; detecting, based on the detector model configured in accordance with the at least one parameter, at least one anomaly in a time series of measurement values of a physical observable monitored by a sensor of the mobile device, and transmitting, to the network node, control data indicative of the at least one anomaly.

Advantageously, detecting the at least one anomaly based on the detector model may reduce battery consumption of the respective mobile device by transmitting essential control data only. Control signaling overhead is reduced. If the labeled anomaly already has location information associated, then the battery consumption can be further reduced since the mobile device is not required to run any positioning method to find the current location.

The term “network node” as used herein may refer to a cloud server infrastructure which renders a service, for example grouping of mobile devices, via available WAN connectivity. The cloud server infrastructure may be implemented by server hardware/software and/or distributed processing. The network node may be part of a wireless network or a data network, e.g., the Internet.

According to some embodiments, the method further comprises implementing group sensor reporting in accordance with at least one location sensing group set-up in accordance with the control data.

Advantageously, implementing group sensor reporting in accordance with determined location sensing groups may reduce battery consumption of the plurality of mobile devices of the respective location sensing group since these mobile devices can be treated as an entity. A group head may be available. Group sensor reporting may be shared amongst grouped devices.

According to some embodiments, the method further comprises: selecting between a periodic report and an aperiodic report for said transmitting of the control data depending on a significance of recognition of the at least one anomaly.

Advantageously, this may expedite grouping of mobile devices, or reduce battery consumption of the respective mobile device, in response to availability of new sensor data.

For example, if the at least one anomaly is recognized with high significance, e.g. with relation to a first given significance threshold, the corresponding control data could be sent to the network node immediately, i.e. reported aperiodically, in order to improve positional accuracy of existing location sensing groups, for example.

Alternatively or additionally, aperiodic reporting may be appropriate if the at least one anomaly is recognized with low significance, for example with relation to a second given significance threshold. In that case, the at least one anomaly may not have been encountered by the network-configured detector model, and the corresponding control data may facilitate grouping of mobile devices to location sensing groups either. Aperiodic reporting may rely on dedicated resources. Here, an uplink scheduling request and a downlink scheduling grant may be communicated in response to a need for aperiodic reporting, to obtain the dedicated resources.

Periodic reporting may be appropriate in all other cases, or when reducing battery consumption is a paramount concern. Periodic reporting may make use of pre-scheduled resources. For example, semi-persistently scheduled resources reoccurring at a certain time pattern/periodic reporting schedule may be used for periodic reporting. Dedicated resources may not be required.

According to some embodiments, the method further comprises: aggregating a plurality of anomalies into a message of the control data in accordance with a periodic reporting schedule.

Advantageously, this may preserve battery resources of the respective mobile device by transmitting detected anomalies less frequently, owing to a transmission overhead of each transmission.

According to a third aspect, a mobile device is provided. The mobile device comprises: a sensor; and a processor adapted to receive, from a network node of a network, downlink control data comprising at least one parameter of a detector model; detect, based on the detector model configured in accordance with the at least one parameter, at least one anomaly in a time series of measurement values of a physical observable monitored by the sensor of the mobile device; and transmit, to the network node, controt data indicative of the at least one anomaly. The mobile device may further comprise a wireless interface adapted to facilitate the receiving and transmitting of the respective control data.

The term “wireless interface” as used herein may refer to a functional entity of a device used to provide radio connectivity to a corresponding radio communication network.

The term “processor” as used herein may refer to a functional entity of a device used to perform method steps provided in a memory of the device.

According to some embodiments, the processor is further adapted to perform the method of various embodiments.

Advantageously, the technical effects and advantages described above in relation with the method according to the second aspect equally apply to the mobile device having corresponding features.

According to a fourth aspect, a network node is provided. The network node comprises: a processor adapted to receive, from each mobile device of a plurality of mobile devices, control data indicative of at least one anomaly detected in a time series of measurement values of a physical observable monitored by a sensor of the respective mobile device; determine, based on a comparison of anomalies indicated by the control data from the plurality of mobile devices, an assignment of the plurality of mobile devices into at least one location sensing group; and implement group sensor reporting in accordance with the at least one location sensing group. The network node may further comprise a network interface adapted to facilitate the receiving of the control data.

The term “network interface” as used herein may refer to a functional entity of a device used to provide network connectivity to a corresponding communication network.

According to some embodiments, the processor is further adapted to perform the method of various embodiments.

Advantageously, the technical effects and advantages described above in relation with the method according to the first aspect equally apply to the network node having corresponding features.

According to a fifth aspect, a system is provided. The system comprises a mobile device of various embodiments, and a network node of various embodiments.

### BRIEF DESCRIPTION OF THE DRAWINGS

Embodiments of the invention will be described with reference to the accompanying drawings, in which the same or similar reference numerals designate the same or similar elements.

FIG. 1 is a schematic diagram illustrating methods according to embodiments.

FIG. 2 is a schematic diagram illustrating upstream training control data communicated in the methods according to embodiments.

FIG. 3 is a schematic diagram illustrating variants of the methods according to embodiments.

FIG. 4 is a schematic diagram illustrating further variants of the methods according to embodiments.

FIG. 5 is a schematic diagram illustrating control data communicated in the methods according to embodiments.

FIG. 6 is a schematic diagram for illustrating a mobile device according to an embodiment.

FIG. 7 is a schematic diagram for illustrating a network node according to an embodiment.

### DETAILED DESCRIPTION OF EMBODIMENTS

Exemplary embodiments of the invention will now be described with reference to the drawings. While some embodiments will be described in the context of specific fields of application, the embodiments are not limited to this field of application. Further, the features of the various embodiments may be combined with each other unless specifically stated otherwise.

The drawings are to be regarded as being schematic representations and elements illustrated in the drawings are not necessarily shown to scale. Rather, the various elements are represented such that their function and general purpose become apparent to a person skilled in the art.

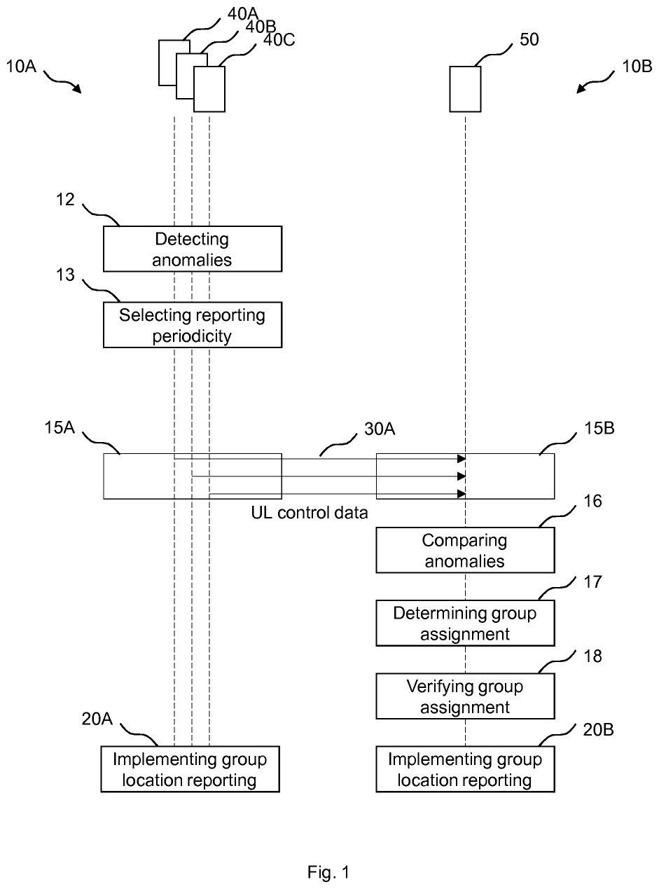

FIG. 1 is a schematic diagram illustrating methods 10A, 10B according to embodiments.

These embodiments implement grouping of mobile devices 40A-40C based on control data 30A indicative of anomalies that are detected 12 without using a network-configured detector model.

Method 10A shown on the left-hand side of FIG. 1 is for operating a mobile device 40A-40C of a plurality of mobile devices 40A-40C, while method 10B depicted on the right-hand side of FIG. 1 is for operating a network node 50.

According to method 10A, each mobile device 40A-40C of the plurality of mobile devices 40A-40C comprises a respective sensor 43, which may be a low-cost sensor such as an accelerometer, microphone, etc. Each sensor 43 monitors a respective physical observable as captured in a respective time series of measurement values. The respective physical observable may be an acceleration; position; rotation; sound pressure; temperature; pressure; luminescence, etc.

Different mobile devices 40A-40C may include corresponding sensors. In some scenarios, each mobile device 40A-40C includes more than a single sensor.

The respective mobile device 40A-40C individually may detect 12 at least one anomaly in the respective time series of measurement values.

If so, then, in the example of FIG. 1, the respective mobile device 40A-40C transmits 15A, to the network node 50, control data 30A indicative of the at least one anomaly. As shown in FIG. 1, transmitting step 15A of method 10A carries out transmission of the control data 30A by the respective mobile device 40A-40C, while receiving step 15B of method 10B executes the corresponding reception of the control data 30A by the network node 50.

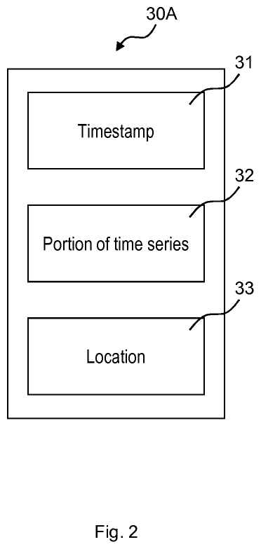

Initially, a default detector model, for example a simple statistical detector model, may assumed, so that the detecting 12 could generally be carried out without any assistance of a network-configured detector model. Therefore, the respective mobile device 40A-40C transmits 15A, to the network node 50, respective uplink control data 30A indicative of the at least one anomaly, cf. FIG. 2. Here, the uplink control data 30A includes a timestamp and an associated portion of the time series of measurement values. Optionally, the uplink control data 30A includes a measured location.

The portion of the time series of measurement values is included in the control data 30A, because typically the untrained detector model is comparably unreliable.

Again referring to FIG. 1, when transmitting 15A the uplink control data, the respective mobile device 40A-40C may select 13 between a periodic report and an aperiodic report of the control data 30A depending on a significance of recognition of the at least one anomaly.

As mentioned previously, detecting 12 is assumed not to rely on a detector model configured in accordance with at least one parameter received from the network node 50. Therefore, the at least one anomaly is not recognized as a “known anomaly pattern”, and aperiodic reporting is selected to provide the control data 30A as soon as possible to the network node 50 in order to take the at least one anomaly into account when creating a network-configured detector model.

According to method 10B, the network node 50 receives 15B, from each mobile device 40A-40C of the plurality of mobile devices 40A-40C, the respective control data 30A.

Then, the network node 50 may compare 16 the anomalies of the plurality of mobile devices 40A-40C based on a correlation model. At least one parameter of the correlation model is configured by a machine learning technique, which may operate based on the time series of measurement values, and may further operate based on the reference control data.

Then, the network node 50 determines 17, based on the comparison 16 of anomalies indicated by the respective control data 30A from the plurality of mobile devices 40A-40C, an assignment of the plurality of mobile devices 40A-40C into at least one location sensing group.

Then, the network node 50 may verify 18 the determined group assignment based on reference control data not originating from the sensors 43 of the plurality of mobile devices 40A-40C, such as parcel lists or an order database, which reflect one or more expected group assignments.

Then, the network node 50 implements 20B group sensor reporting in accordance with the at least one location sensing group. For example, this may involve assigning and communicating respective reporting frequencies to each mobile device 40A-40C in accordance with the respective location sensing group of the at least one location sensing group.

According to method 10A, also each mobile device 40A-40C of the plurality of mobile devices 40A-40C may implement 20A group sensor reporting in accordance with the at least one location sensing group set-up in accordance with the control data 30A. For example, this may involve receiving and applying respective reporting frequencies by each mobile device 40A-40C in accordance with the respective location sensing group of the at least one location sensing group.

FIG. 2 is a schematic diagram illustrating uplink control data 30A communicated in the methods 10A, 10B according to embodiments.

The uplink control data 30A is indicative of at least one of a timestamp 31 of the at least one anomaly, a portion 32 of the time series of measurement values comprising the at least one anomaly, and a location information 33 of the respective mobile device 40A-40C at the time of occurrence of the at least one anomaly.

Assigning of a plurality of mobile devices 40A-40C into a particular location sensing group may require that at least one mobile device 40A-40C of the plurality of mobile devices 40A-40C has provided its location information 33 in the uplink control data 30A transmitted to, and received by, the network node 50.

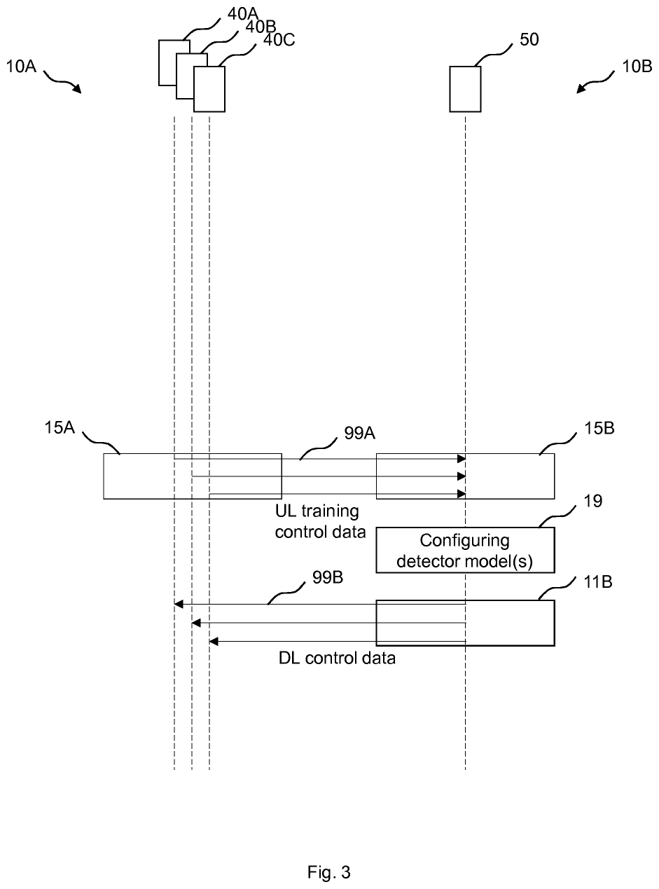

FIG. 3 is a schematic diagram illustrating variants of the methods 10A, 10B according to embodiments.

These embodiments implement a machine learning technique for creating respective detector models used by at least one mobile device 40A-40C of the plurality of mobile devices 40A-40C for detecting the at least one anomaly.

According to method 10B, the network node 50 receives 15B, from at least one mobile device 40A-40C of the plurality of mobile devices 40A-40C, uplink training control data 99A indicative of the time series of measurement values, i.e. the series of measurement values indexed in time order as described above. Here, it is generally not required that the mobile devices 40A-40C have recognized any anomaly in the time series of measurement values. For example, there may not be a detector model available at the mobile devices 40A-40C.

Then, the network node 50 configures 19, based on the uplink training control data 99A, at least one parameter of the respective detector model used by the at least one mobile device 40A-40C of the plurality of mobile devices 40A-40C for detecting the at least one anomaly. The configuring step 19 may additionally be based on a machine learning technique.

Configuring 19 the at least one parameter of the respective detector model may comprise training a respective detector model used by the at least one mobile device 40A-40C of the plurality of mobile devices 40A-40C for detecting the anomalies. For example, this training may relate to unsupervised learning based on training examples consisting of an input value or vector and a desired output value, wherein the uplink training control data from the plurality of mobile devices is used as input.

Then, the network node 50 transmits 11B, to the at least one mobile device 40A-40C of the plurality of mobile devices 40A-40C, downlink control data 99B comprising at least one parameter of the respective detector model.

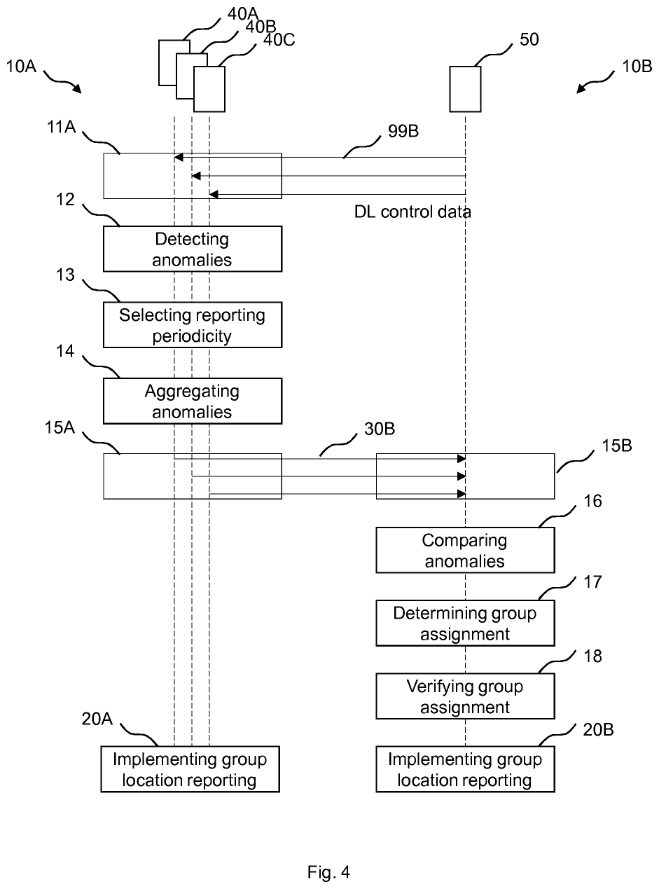

FIG. 4 is a schematic diagram illustrating further variants of the methods 10A, 10B according to embodiments.

These embodiments implement grouping of mobile devices 40A-40C based on control data 30A indicative of anomalies that are detected 12 using a network-configured detector model.

Same reference numerals as in FIG. 2 designate the same elements, and require no further mention.

According to method 10A, the respective mobile device 40A-40C receives 11A the downlink control data 99B in response to transmission 11B by the network node 50. The downlink control data comprises at least one parameter of a respective detector model. For example, a detector model may be trained using received uplink training control data 99A. The detector model typically consists of an algorithm/method and parameters. A very basic example would be that the training finds that linear regression could be used, y=B0+B1*x. The model will then have B0 and B1 as parameters. Y can then be predicted by providing x. Additionally, it may be possible to update the algorithm/method of the detector model.

Then, the respective mobile device 40A-40C detects 12, based on the detector model configured in accordance with the at least one parameter, at least one anomaly in a time series of measurement values of a physical observable monitored by a sensor 43 of the mobile device 40A-40C.

Then, the respective mobile device 40A-40C may select 13 between a periodic report and an aperiodic report for said transmitting of the control data 30A, 30B depending on a significance of recognition of the at least one anomaly.

In accordance with a selected periodic reporting schedule, the respective mobile device 40A-40C may aggregate 14 a plurality of anomalies into a message of the control data 30B.

Then, the respective mobile device 40A-40C transmits 15A, to the network node 50, control data 30A, 30B indicative of the at least one anomaly. For example, it is possible that a same mobile device 40A-40C of the plurality of mobile devices 40A-40C selectively transmits 15A control data 30A or control data 30B indicative of the at least one anomaly, as required depending on the corresponding significance of recognition of the underlying at least one anomaly.

In particular, transmitting 15A control data 30B comprising a label 34 for a “known anomaly pattern” may require less battery resources than transmitting 15A uplink control data 30A comprising a portion 32 of a time series indicative of measurement values and location information 33.

In the example of FIG. 4, the control data 30B is transmitted.

According to method 10B, the network node 50 receives 15B, from each mobile device 40A-40C of the plurality of mobile devices 40A-40C, the respective control data 30B. Generally, some mobile devices 40A-40C may transmit the control data 30A; while other mobile devices 40A-40C may transmit the control data 30B.

From there, the same method sequence as in FIG. 2 may be performed, based on either control data 30A or control data 30B.

In particular, comparing 16 the anomalies of the plurality of mobile devices 40A-40C may be carried out between labels 34 having a same or similar timestamp 31, as well as between portions of time series 32 having a same or similar timestamp 31.

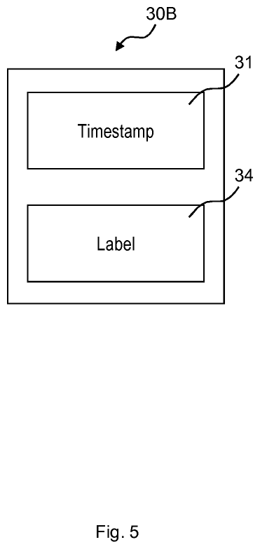

FIG. 5 is a schematic diagram illustrating control data 30B communicated in the methods 10A, 10B according to embodiments.

The control data 30B is indicative of at least one of a timestamp 31 of the at least one anomaly, and a label 34 associated with the at least one anomaly. The label 34 is identified in accordance with a respective detector model used by the respective mobile device 40A-40C of the plurality of mobile devices 40A-40C for detecting the anomalies in the time series of measurement values.

As will be appreciated, the control data 30B has a reduced size if compared to the control data 30A.

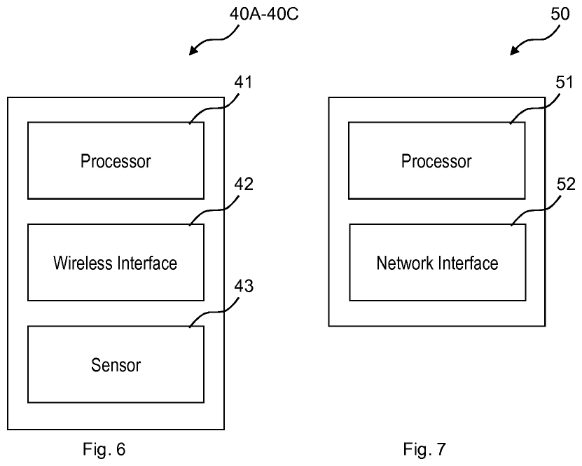

FIG. 6 is a schematic diagram for illustrating a mobile device 40A-40C according to an embodiment.

The mobile device 40A-40C comprises a processor 41; a wireless interface 42 and a sensor 43.

The processor 41 and the wireless interface 42 are adapted to receive 11A, from a network node 50 of a network, downlink control data comprising at least one parameter of a detector model.

The processor 41 is adapted to detect 12, based on the detector model configured in accordance with the at least one parameter, at least one anomaly in a time series of measurement values of a physical observable monitored by the sensor 43 of the mobile device 40A-40C.

Additionally, the sensor 43 could include location estimation capability to generate location information.

The processor 41 and the wireless interface 42 are further adapted to transmit 15A, to the network node 50, control data 30A, 30B indicative of the at least one anomaly.

The processor 41 is further adapted to perform the method 10A of operating a mobile device 40A-40C according to various embodiments.

FIG. 7 is a schematic diagram for illustrating a network node 50 according to an embodiment.

The network node 50 comprises a processor 51 and a network interface 52.

The processor 51 and the network interface 52 are adapted to receive 15B, from each mobile device 40A-40C of a plurality of mobile devices 40A-40C, control data 30A, 30B indicative of at least one anomaly detected in a time series of measurement values of a physical observable monitored by a sensor 43 of the respective mobile device 40A-40C.

The processor 51 is adapted to determine 17, based on a comparison of anomalies indicated by the control data 30A, 30B from the plurality of mobile devices 40A-40C, an assignment of the plurality of mobile devices 40A-40C into at least one location sensing group.

The processor 51 is further adapted to implement 20B group sensor reporting in accordance with the at least one location sensing group, and to perform the method 10B of operating a network node 50 according to various embodiments.

1. A method, comprising:
receiving, from each mobile device of a plurality of mobile devices, control data indicative of at least one anomaly detected in a time series of measurement values of a physical observable monitored by a sensor of the respective mobile device,
determining, based on a comparison of anomalies indicated by the control data from the plurality of mobile devices, an assignment of the plurality of mobile devices into at least one location sensing group, and
implementing group sensor reporting in accordance with the at least one location sensing group.

2. The method of claim 1,
wherein the control data is indicative of at least one of:
a timestamp of the at least one anomaly, and
a label associated with the at least one anomaly, the label being identified in accordance with a respective detector model used by the respective mobile device of the plurality of mobile devices for detecting the anomalies in the time series of measurement values.

3. The method of claim 1,
wherein the control data is indicative of at least one of:
a portion of the time series of measurement values comprising the at least one anomaly, and
a location information of the respective mobile device at the time of occurrence of the at least one anomaly.

4. The method of claim 1,
wherein the physical observable is selected from the group comprising: acceleration; position; rotation; sound pressure; temperature; pressure; luminescence.

5. The method of claim 1, further comprising:
comparing the anomalies of the plurality of mobile devices based on a correlation model,
wherein at least one parameter of the correlation model is configured by a machine learning technique.

6. The method of claim 5,
wherein the machine learning technique operates based on the time series of measurement values.

7. The method of claim 1:
verifying the determined assignment based on reference control data not originating from the sensors of the plurality of mobile devices.

8. The method of claim 5,
wherein the machine learning technique further operates based on the reference control data.

9. The method of claim 1, further comprising:
receiving, from at least one mobile device of the plurality of mobile devices, uplink training control data indicative of the time series of measurement values,
based on the uplink training control data: configuring at least one parameter of the respective detector model used by the at least one mobile device of the plurality of mobile devices for detecting the anomalies, and
transmitting, to the at least one mobile device of the plurality of mobile devices, downlink control data comprising at least one parameter of the respective detector model.

10. The method of claim 9, wherein configuring the at least one parameter of the respective detector model comprises:
training a respective detector model used by the at least one mobile device of the plurality of mobile devices for detecting the anomalies.

11. A method of operating a mobile device, comprising:
receiving, from a network node of a network, downlink control data comprising at least one parameter of a detector model,
detecting, based on the detector model configured in accordance with the at least one parameter, at least one anomaly in a time series of measurement values of a physical observable monitored by a sensor of the mobile device, and
transmitting, to the network node, control data indicative of the at least one anomaly.

12. The method of claim 11, further comprising
implementing group sensor reporting in accordance with at least one location sensing group set-up in accordance with the control data.

13. The method of claim 11, further comprising:
selecting between a periodic report and an aperiodic report for said transmitting of the control data depending on a significance of recognition of the at least one anomaly.

14. The method of claim 11, further comprising:
aggregating a plurality of anomalies into a message of the control data in accordance with a periodic reporting schedule.

15. A mobile device, comprising
a sensor; and
a processor adapted to
receive, from a network node of a network, downlink control data comprising at least one parameter of a detector model,
detect, based on the detector model configured in accordance with the at least one parameter, at least one anomaly in a time series of measurement values of a physical observable monitored by the sensor of the mobile device, and
transmit, to the network node, control data indicative of the at least one anomaly.

16-19. (canceled)

20. The mobile device of claim 15,
wherein the control data is indicative of at least one of:
a timestamp of the at least one anomaly, and
a label associated with the at least one anomaly, the label being identified in accordance with a respective detector model used by the respective mobile device of the plurality of mobile devices for detecting the anomalies in the time series of measurement values.

21. The mobile device of claim 15, wherein the processor is further adapted for:
comparing the anomalies of the plurality of mobile devices based on a correlation model,
wherein at least one parameter of the correlation model is configured by a machine learning technique.

22. The mobile device of claim 15,
wherein the machine learning technique operates based on the time series of measurement values.

23. The mobile device of claim 15, wherein the processor is further adapted for:
verifying the determined assignment based on reference control data not originating from the sensors of the plurality of mobile devices.

24. The mobile device of claim 18,
wherein the machine learning technique further operates based on the reference control data.
